(19) United States
(12) Patent Application Publication
(10) Pub. No.: US 2026/0343655 A1
(43) Pub. Date: Oct. 29, 2026

(54) DATA SESSION ESTABLISHMENT ON A DIFFERENT NETWORK SLICE

(71) Applicant: LENOVO (SINGAPORE) PTE. LTD., Singapore (SG)

(72) Inventor: Genadi VELEV, Darmstadt (DE)

(21) Appl. No.: 19/110,765

(22) PCT Filed: Sep. 19, 2023
(86) PCT No.: PCT/IB2023/059280

§ 371 Date: Mar. 11, 2025

Related U.S. Application Data
(60) Provisional application No. 63/407,942, filed on Sep. 19, 2022.

(51) Int. Cl. H04W 76/18; H04W 48/18

(52) U.S. Cl. CPC H04W 76/18; H04W 48/18

(57) ABSTRACT

In a communication system including network slices, a first network slice associated with a User equipment (UE) may be replaced. An Access and Mobility management Function (AMF) of the communication system may determine that the UE should cease or restrict use of the first network slice, select a second network slice as a replacement, and indicate to the UE that the second network slice is an allowed network slice, that the first network slice is to be replaced by it, that the first network slice is excluded from the allowed network slices, or combinations thereof. The UE may subsequently send the AMF a data session establishment request comprising indications of the second network slice and of the replacement. The AMF may select a Session Management Function (SMF) according to the second network slice and provide the SMF an indication that the second network slice replaces the first network slice.

### CROSS REFERENCE TO RELATED APPLICATIONS

This application claims priority to U.S. Provisional Patent Application No. 63/407,942, filed on Sep. 19, 2022, entitled DATA SESSION ESTABLISHMENT ON A DIFFERENT NETWORK SLICE, which is hereby incorporated by reference in its entirety.

### TECHNICAL FIELD

The present disclosure relates to wireless communications, and more specifically to establishment of a data session on a communication network including a plurality of network slices.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

A feature of 5G network systems (abbreviated as 5GS) is Network Slicing. Network Slicing enables the network operators to divide (“slice”) the network in finer granularity of complete networks in order to provide customized network connectivity, features, or both to customers and/or external service providers.

A Network Slice is a logical network that comprises of a set of network functions and corresponding resources (e.g., computing, storage, and networking resources, among others) necessary to provide certain network capabilities and network characteristics. A Network Slice can include one or more Core Network (5G core network, 5GC) control plane and user plane Network Functions (NFs), and one or more Access Networks (e.g., a 5G radio access network, a fixed access network, or a combination thereof).

A UE in a communication network can be configured with network slice relevant information, referred as Network Slice Selection Assistance information (NSSAI). The NSSAI may consist of one or more single Network Slice Selection Assistance information (S-NSSAIs). Data sessions of the UE, such as Protocol Data Unit (PDU) sessions, may be established on one or more of the Network Slices of the communication network in accordance with the NSSAI.

### SUMMARY

The present disclosure relates to methods, apparatuses, and systems that support replacing, in a communication system supporting a plurality of network slices, a first network slice for a data session of a wireless device with a second network slice.

Some implementations of the method and apparatus described herein may include a first network function of a communication network configured to determine that a UE should cease or restrict its use of a first network slice indicated as an allowed network slice of the UE; select a second network slice as a replacement for the first network slice; providing a first indication to the UE, the first indication indicating that a second network slice is an allowed network slice, that the first network slice is to be replaced by the second network slice, or combinations thereof; receive a second indication from the UE for a data session establishment request comprising the second network slice and an indication that the second network slice replaces the first network slice; select a second network function of the communication network according to the second network slice; and provide to the second network function a third indication indicating that the second network slice replaces the first network slice.

Some implementations of the method and apparatus described herein may further include providing a UE Configuration Update (UCU) command message to the UE, the UCU command message including an indication that the second network slice is an allowed slice, an indication that the first network slice is to be replaced by the second network slice, or both; and receiving from the UE a UCU complete message responsive to the UCU command message.

Some implementations of the method and apparatus described herein may further include receiving, from the UE, a first data session establishment request for the first network slice; and determining that the UE should cease or restrict its use of a first network slice in response to receiving the first data session establishment request.

In some implementations of the method and apparatuses described herein, providing the first indication to the UE comprises providing to the UE a message indicating that the first data session establishment request has been rejected, wherein the message further indicates that the UE may reestablish the data session on a different network slice, that the first network slice is to be replaced, that the second network slice replaces the first network slice, or a combination thereof.

In some implementations of the method and apparatuses described herein providing to the second network function the third indication is performed in response to receiving the second indication.

In some implementations of the method and apparatuses described herein, the second network function is provided the second indication using a request service operation, and the request service operation further includes information from the second data session establishment request and is configured to cause the second network function to create a data session on the second network slice.

In some implementations of the method and apparatuses described herein, the first network slice being an allowed network slice of the UE is determined according to Network Slice Selection Assistance Information (NSSAI) of the UE.

In some implementations of the method and apparatuses described herein, selecting the second network slice comprises determining that the second network slice is not an allowed network slice of the UE.

In some implementations of the method and apparatuses described herein, determining that the second network slice is not an allowed network slice of the UE the second network slice comprises determining that the second network slice is not an allowed network slice of the UE according to Network Slice Selection Assistance Information (NSSAI) of the UE, according to the UE subscription data, according to UE Route Selection Policy (URSP) rules for the UE and application traffic of the UE using the first network slice, or combinations thereof.

In some implementations of the method and apparatuses described herein, determining the second network slice not being the allowed network slice according to the URSP rules for the UE and the application traffic of the UE using the first network slice includes: providing to a third network function of the communication network a request to determine whether the second network slice qualifies as a network slice to be used alternatively to the first network slice according to the URSP rules; and receiving from the third network function an indication of whether the second network slice qualifies as an allowed network slice according to the URSP rules.

Some implementations of the method and apparatus described herein may include a UE, comprising a processor, and a memory coupled with the processor, wherein the processor is configured to cause the UE to receive a first indication from a network function that indicates a second network slice replaces a first network slice; and transmit a second indication to the network function for a data session establishment request comprising the second network slice and an indication that the second network slice replaces the first network slice.

In some implementations of the method and apparatuses described herein, the processor is further configured to cause the UE to receive, from the network function, a rejection of a previous data session establishment request before receiving the first indication from the network function.

In some implementations of the method and apparatuses described herein, the rejection of the first data session establishment request comprises a UE Configuration Update (UCU) command message, the UCU command message including an indication that the second network slice is an allowed slice, an indication that the first network slice is to be replaced by the second network slice, or both.

In some implementations of the method and apparatuses described herein, the rejection of the first data session establishment request comprises a message indicating that the first data session establishment request has been rejected, the message further indicating that the first network slice is to be replaced, that the second network slice replaces the first network slice, or both.

In some implementations of the method and apparatuses described herein, the processor is further configured to cause the UE to receive, from the network function, information indicating that a second network slice is an allowed network slice, that the first network slice is to be replaced by the second network slice, or combinations thereof.

In some implementations of the method and apparatuses described herein, the information is included in a rejection of a previous data session establishment request.

### BRIEF DESCRIPTION OF THE DRAWINGS

FIG. 1 illustrates an example of a wireless communications system that supports replacing a first network slice with a second network slice in accordance with aspects of the present disclosure.

FIG. 2 illustrates an architecture of a communication system that supports replacing a first network slice with a second network slice in accordance with aspects of the present disclosure.

FIG. 3 illustrates a method of reconfiguring a UE in a communication network with an alternative second S-NSSAI (e.g. S-NSSAI-2) by using network slice mapping information.

FIGS. 4 and 5 are flowcharts of methods that supports data session establishment on a different network slice in accordance with aspects of the present disclosure.

FIG. 6 illustrates an example of a block diagram of a device that supports data session establishment on a different network slice in accordance with aspects of the present disclosure.

### DETAILED DESCRIPTION

This disclosure proposes a method to determine in a network (e.g. in AMF, NSSF or PCF) a second/alternative/compatible network slice (e.g. S-NSSAI-2) to a first/old network slice (e.g. S-NSSAI-1 which is to be replaced by the S-NSSAI-2) and to configure a UE correspondingly to use the S-NSSAI-2 instead of S-NSSAI-1 for establishing new PDU Session, which are supposed to be established on S-NSSAI-1 according the URSP rules or UE's local configuration. According to this disclosure, the S-NSSAI-2 can be used instead the S-NSSAI-1 without updating the URSP rules or UE's local configuration.

For example, in embodiments, an Access and Mobility management Function (AMF) of a communication network that includes a plurality of network slices may determine that a User Equipment (UE) should cease or restrict its use of a first network slice indicated as an allowed network slice of the UE, may select a second network slice as a replacement for the first network slice, and may provide a first indication to the UE, the first indication indicating that a second network slice is an allowed network slice, that the first network slice is to be replaced by the second network slice, that the first network slice is excluded from the allowed network slices, or combinations thereof. The UE may, in response to receiving the first indication, provide, to the AMF, a second indication including a data session establishment request for the second network slice and an indication that the second network slice replaces the first network slice. In response to receiving the second indication from the user equipment, the AMF may select a Session Management Function (SMF) of the communication network according to the second network slice; and provide to the SMF a third indication indicating that the second network slice replaces the first network slice. The AMF and the UE may then receive respective responses originating at the SMF and indicating the data session establishment on the second network slice.

An advantage of the disclosed solutions that the AMF rejects the UE request for PDU Session establishment, when the AMF determines that the PDU Session should be established on alternative S-NSSAI-2. The AMF includes an appropriate reject cause that the PDU Session should be re-established by using an alternative network slice (e.g. the S-NSSAI-2) which replaces the current S-NSSAI-1.

It is advantageous that the UE is configured in the MM sub-layer appropriately that the S-NSSAI-2 is allowed and that S-NSSAI-2 replaces S-NSSAI-1, as the UE can appropriately apply other network slice features like Network Slice AS Groups, or the UE would provide the correct S-NSSAI-2 to the access stratum (AS), so that the NG-RAN can apply the appropriate access control or AMF selection.

Aspects of the present disclosure are described in the context of a wireless communications system. Aspects of the present disclosure are further illustrated and described with reference to device diagrams and flowcharts.

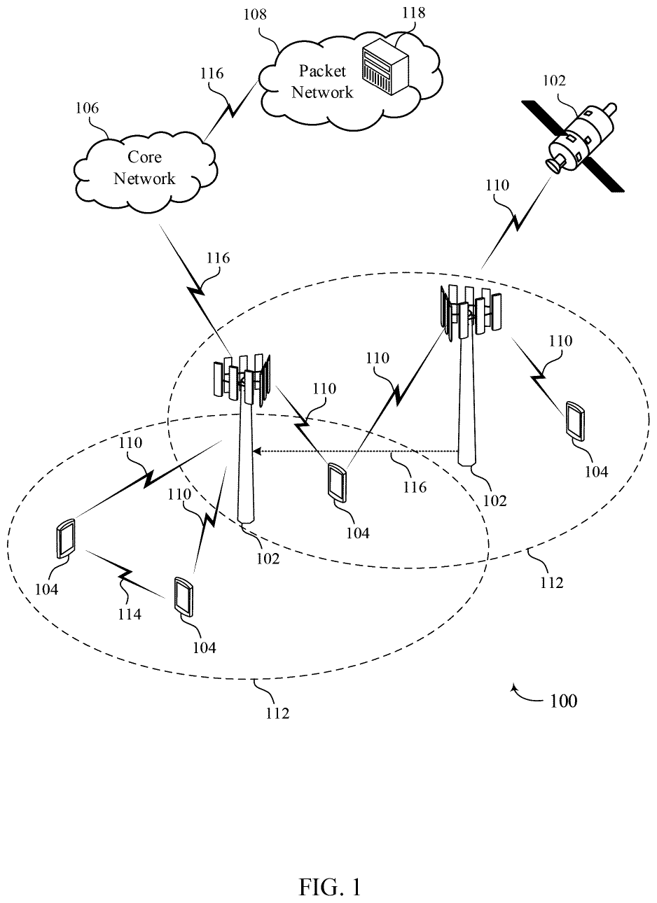

FIG. 1 illustrates an example of a wireless communications system 100 that supports changing which network slice a data session for a user equipment (UE) is established on a different slice in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N3, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The core network 106 may support user authentication, access authorization, tracking, connectivity, and other access, routing, or mobility management and session management functions. The core network 106 may be an evolved packet core (EPC), or a 5G core (5GC), which may include a control plane entity that manages access and mobility (e.g., a mobility management entity (MME), an access and mobility management functions (AMF), Session Management Function (SMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul or broadband links 116 (e.g., via an N5 (in the control plane), N6 (in the user plane) or another network interface). The packet data network 108 may include an application server 118. In some implementations, one or more UEs 104 may communicate with the application server 118. A UE 104 may establish a session (e.g., a data session, a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. # Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The wireless communications system 100 may support Network Slicing. Network Slicing enables the network operators to divide (“slice”) the capabilities of the wireless communications system 100 in finer granularity than complete networks in order to provide customized network connectivity, features, or both to customers, external service providers, and the like.

A Network Slice is a logical network that comprises of a set of network functions and corresponding resources (such as computing, storage, and networking resources) necessary to provide the network capabilities and network characteristics corresponding to the Network Slice. A Network Slice can include one or more Core Network (5G core network, 5GC) control plane and user plane Network Functions (NFs), and one or more Access Networks (e.g., one or more 5G radio access networks, one or more fixed access networks, or combinations thereof).

A UE 104 may be configured with network slice relevant information, which is referred as Network Slice Selection Assistance information (NSSAI). The NSSAI may consist of one or more single Network Slice Selection Assistance information (S-NSSAIs).

The UE 104 may request registration to a network slice by sending to the wireless communications system 100 a NAS registration request message including a Requested NSSAI containing a list of one or more S-NSSAIs to which the UE 104 wants to register. The wireless communications system 100 may send to the UE 104, in a registration accept message or in a UE configuration update command message, one or more of the following elements or NSSAI(s) related to the network slice configuration of the UE 104: an allowed NSSAI, a configured NSSAI, a rejected NSSAI, a pending NSSAI, or combinations thereof, wherein each NSSAI respectively indicates one or more S-NSSAIs.

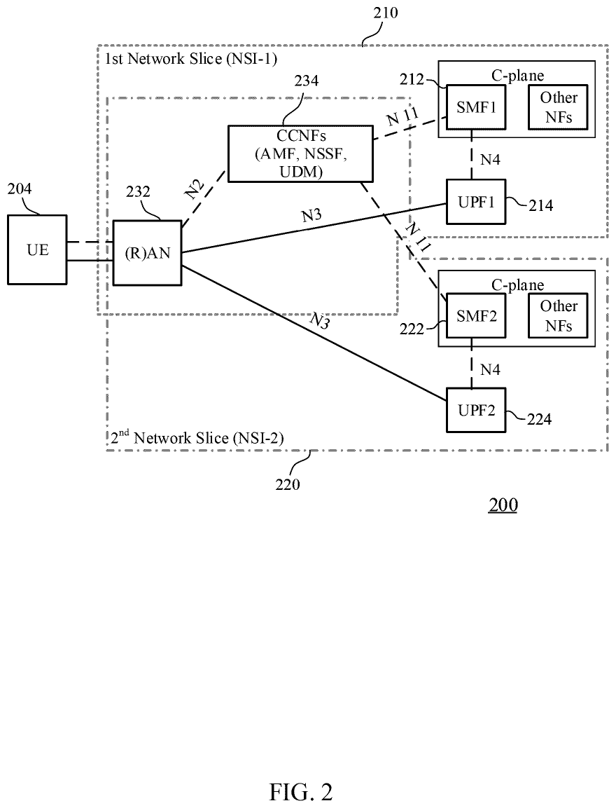

FIG. 2 shows an example 5GS architecture for a UE 204 associated with two network slices in a communication system 200, wherein the network slices are deployed correspondingly over a first network slice instance 210 (e.g. “NSI-1”) and a second network slice instance 220 (e.g., “NSI-2”). The communication system 200 may correspond to the wireless communication system 100 of FIG. 1, and the UE 204 may correspond to the UE 104 of FIG. 1. Although the communication system 200 is shown with two network slices, embodiments are not limited thereto.

In the illustrative embodiment of FIG. 2, a (radio) access network (R)AN 232 (that is, an access network that may include but is not limited to a Radio Access Network) is part of the both the first and second network slices instances 210 and 220 and is shared, however, embodiment are not limited thereto. The (R)AN 232 may correspond to the network entities 102 of FIG. 1. The Control Plane (C-plane) part of the network slices has Common Control-plane Network Functions (CCNFs) 234 and one or more dedicated C-plane Network (CN) Functions for each network slice. For example, in the illustrative embodiment of FIG. 2, the first network slice instance 210 includes a first Session Management Function SMF1, and the second network slice instance 220 includes a second Session Management Function SMF2.

In addition, each the network slice instance may include one or more dedicated User-plane Functions; accordingly, in the illustrative embodiment of FIG. 2, the first network slice instance 210 includes a first User Plane Function (UPF1) 214, and the second network slice instance 220 includes second User Plane Function (UPF2) 224.

Components of the communication system 200 are shown coupled through 5G reference points N2, N3, N4, N11. In FIG. 2, the (R)AN 232 is coupled to the CCNFs 234 using an N2 reference point and to the first and second UPFs 214 and 224 using respective N3 reference points. The CCNFs 234 is coupled to the first and second SMFs 212 and 222 using respective N11 reference points. The first SMF 212 is coupled to the first UPF 214 using an N4 reference point, and the second SMF 222 is coupled to the second UPF 224 using an N4 reference point.

FIG. 2 does not include all NFs and all reference points of the communication system 200. More information about the functionality of NFs (e.g. AMF, NSSF, SMF, UPF, etc.), about reference points, and about the 5GS can be found in the 3^{rd} Generation Partnership Project (3GPP) Technical Specification (TS) 23.501, V17.4.0, 2022-06, “System Architecture for the 5G System” (hereinafter, TS 23.501) and the 3GPP TS 23.502, V17.4.0, 2022-06, “Procedures for the 5G System” (hereinafter, TS 23.501).

The scenarios and candidate solutions on the support of network slice service continuity during UE mobility due to no support of the network slice or resource limitation of the network slice in the target RAN node have been studied in the 3GPP Technical Report (TR) 38.832, V17.0.0, 2021-09, “Study on enhancement of Radio Access Network (RAN) slicing” (hereinafter, TR 38.832), which studied scenarios that may occur when network slices are not required to be available in all tacking areas (TAs) of a network. The scope of the studied solutions was to enable the slice re-mapping within the radio access network (RAN) or based on deployment improvements, however, the solutions with 5GC and UE impacts were discouraged.

The following scenarios (or events) may happen in the communication system 200 which result in inability to use a first network slice (e.g., the first network slice 210, corresponding to S-NSSAI-1), which as a result is to be exchanged with a second network slice (e.g., the second network slice 220, corresponding to S-NSSAI-2):
1. No Mobility Scenario
   a) network slice or network slice instance is overloaded or undergoing planned maintenance in CN (e.g., network slice termination).
   b) network performance of the network slice cannot meet the Service Level Agreement (SLA) agreed with the network slice customer and therefore the UE should use another network slice which would better fulfil the SLA.
2. Mobility scenario, especially in case of Inter-registration area (RA) mobility where a network slice or network slice instance is overloaded in the target CN.

In summary, the existing network slice (S-NSSAI-1) or network slice instance cannot be used, or the existing network slice instance cannot meet the performance requirements of the applications and therefore there may be another (alternative) network slice (e.g. S-NSSAI-2) which replaces S-NSSAI-1.

If the UE 204 initiates the establishment of a new data session (referred to hereafter as a PDU Session) associated with S-NSSAI-1 and the UE sends to the AMF of the CCNFs 234 a NAS message requesting the PDU Session establishment, it is inefficient for the AMF to forward the PDU Session establishment request to a SMF serving S-NSSAI-2 (such as the second SMF 222) and let that SMF continue the PDU Session establishment. Furthermore, the UE 204 may be configured to apply other network slicing features e.g.:
Network Slice AS Groups (e.g. NSAG as described in clause 5.15.14 in 3GPP TS 23.501), or
Network Slice Simultaneous Registration Group (NSSRG), or
the UE 204 would need to provide the correct S-NSSAI-2 to the access stratum (AS), so that the NG-RAN can apply the appropriate access control or AMF selection.

Therefore, the UE 302 should use and apply the correct S-NSSAI (i.e., S-NSSAI-2) when establishing the PDU Session.

The UE reconfiguration performed by the SMF affects only the current PDU Session. A mechanism is required to generally re-configure the UE to use the alternative S-NSSAI-2 for any new PDU Sessions that was to be established on S-NSSAI-1.

3GPP TR 38.832 studied network slice changes such as during UE mobility when there is no support of a first network slice in the target cell or there are resource limitations on the first network slice in the target RAN node, calling such changes slice remapping. The drawback of the proposals in 3GPP TR 38.832 is that the slice remapping is done transparently to the UE's NAS layer or even transparently to the UE's AS layer. In other words, the slice re-mapping is done in the RAN side without impacts to the UE's NAS layer or 5G core network (5GCN or 5GC).

However, in some scenarios, such transparency is inappropriate because the change of the network slice requires that the UE be reconfigured with the network slice which exchanges for the first network slice.

In 3GPP TR 23.700-41 V0.4.0, 2022-08, “Study on enhancement of network slicing; Phase 3” (hereinafter TR 23.700-41), it is proposed that the SMF send the alternative S-NSSAI to the UE in the NAS SM signaling. But the proposals do not make clear why the NAS SM signaling should send the new alternative S-NSSAI (e.g. S-NSSAI-2) and how the UE is supposed to process such an alternative S-NSSAI for different PDU Sessions on the old S-NSSAI (e.g. S-NSSAI-1).

Embodiments of the present disclosure determine in the network (e.g. in the AMF, NSSF or PCF) a second alternative compatible network slice (e.g. S-NSSAI-2) to a first old network slice (e.g. S-NSSAI-1 which is to be replaced by the S-NSSAI-2) and configure the UE correspondingly to use the S-NSSAI-2 instead of S-NSSAI-1 for establishing one or more new PDU Session, which were supposed to be established on S-NSSAI-1 according the UE Route Selection Policy (URSP) rules or the UE's local configuration.

There are several scenarios regarding how the second alternative network slice (S-NSSAI-2) relates to the UE's subscribed S-NSSAI(s) list stored in the UE subscription data and whether the S-NSSAI-2 is part of an additional Route Selector Descriptor (RSD) to an URSP rule including RSD for S-NSSAI-1:

In a first scenario, the S-NSSAI-2 is part of the Subscribed S-NSSAIs, but the matched URSP rule which contains an RSD with S-NSSAI-1 does not contain additional RSD with S-NSSAI-2. In such case, in order for the UE to be able to establish a PDU Session, it is required that S-NSSAI-1 is part of the Allowed NSSAI. However, as the S-NSSAI-1 should be replaced with S-NSSAI-2, it is proposed that the UE is configured with additional information that S-NSSAI-1 is replaced by_S-NSSAI-2. In one alternative, this configuration is similar to the network slice mapping information (e.g. the Mapping Of Allowed NSSAI information), which is provided to the UE in roaming cases; whereas in another alternative this configuration comprises a new network slice replacing information. Such configuration can be provided at the NAS MM sub-layer and can be sent to the UE either via UCU procedure or via Registration Procedure. Such configuration can be part of the Allowed NSSAI, Configured NSSAI or can be an independent IE sent from the AMF to the UE (e.g. Replaced NSSAI).

In a second scenario, the S-NSSAI-2 is not part of the Subscribed S-NSSAIs, but the S-NSSAI-2 cannot be added to the Allowed NSSAI, as the S-NSSAI-2 is not supported in the UE's current TA or rejected due to other reason (e.g. due to NSSAA failure). Then a new alternative S-NSSAI would be required, which may not be part of the Subscribed S-NSSAIs—see bullet d).

In a third scenario, the S-NSSAI-2 is not part of the Subscribed S-NSSAIs and Configured NSSAI (in non-roaming case) or not part of the Configured NSSAI (in roaming case). The UE cannot request and use S-NSSAI-2 unless the S-NSSAI-2 is not part of the UE's configured NSSAI.

This disclosure describes how the S-NSSAI-2 can be used instead the S-NSSAI-1 without updating the URSP rules for the UE or a UE's local configuration.

Embodiments may be characterized by one or more of following features:

In embodiments characterized by a first feature, the UE may send to the AMF a request for new PDU Session establishment to S-NSSAI-1 (e.g. a NAS message containing the S-NSSAI-1, DNN-1, Request Type, N1 SM container, etc.).

In embodiments characterized by a second feature, the AMF determines that a new S-NSSAI-2 should replace the old S-NSSAI-1. The AMF decides to update the UE mobility management (MM) network slice configuration by performing at least one of: including the S-NSSAI-2 in the allowed NSSAI, indicating that the S-NSSAI-2 replaces the S-NSSAI-1 and keeping the S-NSSAI-1 as allowed, but marking it that it should be replaced by S-NSSAI-2.

Further, in embodiments characterized by the second feature, the AMF performs at least one of a first process and a second process, described below:

In the first process, if the S-NSSAI-2 is part of the UE's subscribed and/or configured S-NSSAIs, in non-roaming case the AMF determines that the S-NSSAI-2 can be included in the Allowed NSSAI. If S-NSSAI-2 is not yet part of the Allowed NSSAI, the AMF triggers the UCU procedure to update the UE slice configuration to include the S-NSSAI-2 in the Allowed NSSAI. If the S-NSSAI-2 is not part of the UE's subscribed and/or configured S-NSSAIs, the AMF determines to configure the UE using the network slice mapping mechanism, i.e. the S-NSSAI-2 is provided to the UE in the Configured NSSAI and corresponding Mapping Of Configured NSSAI information that it maps to S-NSSAI-1 (e.g. as S-NSSAI-1 as HPLMN S-NSSAI value).

In addition, in the first process, the S-NSSAI-1 is marked as allowed but with restriction or to be replaced (e.g. the marking can be implicit if the S-NSSAI-1 is indicated to be replaced). The AMF may send the information that S-NSSAI-2 replaces S-NSSAI-1 either in the UCU command message or in the rejected NAS message as described in steps S316-1 and S316-2). The AMF may provide the S-NSSAI-2 in the Allowed NSSAI with a corresponding “Mapping Of Allowed NSSAI To Replaced NSSAI” information. The “Mapping Of Allowed NSSAI To NSSAI To Replaced NSSAI” (e.g. for short “Replaced NSSAI”) information indicates that the S-NSSAI-2 is mapped to S-NSSAI-1 which is to be replaced. This information is stored in the UE separately from the Mapping Of Allowed NSSAI information. The UE stores the network slicing configuration information that S-NSSAI-2 replaces S-NSSAI-1 and applies it for PDU Session(s) establishment for PDU Sessions which are triggered based on URSP rules including the S-NSSAI-1. The AMF then may perform the second process.

In the second process, the AMF rejects the UE's request to establish new PDU Session by sending an appropriate reject cause value indicating to re-establish the PDU Session on a new network slice (e.g. S-NSSAI-2) which replaces the old network slice (e.g. S-NSSAI-1). For example, the AMF may include “Mapping Of Allowed NSSAI To Replaced NSSAI” information in the reject message, if the S-NSSAI-2 is already in the Allowed NSSAI or if the first process was not performed.

In embodiments characterized by a third feature, the UE uses the URSP rule to initiate PDU Session establishment to S-NSSAI-1, but based on the configuration in steps S318, S320, and/or S322, the UE includes in the NAS message for the PDU Session establishment request the S-NSSAI-2 and the associated replaced S-NSSAI-1.

Embodiments may operate in a scenario in which the S-NSSAI-2 is not part of the UE's Subscribed S-NSSAIs or configured NSSAI, therefore, the network (AMF, optionally together with the NSSF) determines whether to provide the UE with the S-NSSAI-2 configuration (e.g. to replace the S-NSSAI-1) either in the Configured NSSAI and in the Allowed NSSAI, or in the Allowed NSSAI only. Notably, the Configured NSSAI for a PLMN/SNPN provides configuration for the whole PLMN/SNPN, whereas the Allowed NSSAI provide configuration for the current Registration Area (RA). An advantage of including the S-NSSAI-2 in the Configured NSSAI is that the UE will be able to request registration to S-NSSAI-2 when performing Mobility Registration Update (MRU) request procedure (e.g., upon leaving the current RA). In contrast, if the S-NSSAI-2 is not included in the Configured NSSAI, the UE would request the S-NSSAI-1 when performing the MRU procedure, and the AMF may determine whether to send in the RA message the configuration information that S-NSSAI-2 is in the Allowed NSSAI and that the S-NSSAI-2 replaces the S-NSSAI-1. In other words, the network operator may wish that the network (e.g. AMF/NSSF) configures the S-NSSAI-2 and the associated replacement of S-NSSAI-1 by S-NSSAI-2 only in the configuration in the current RA (i.e. in the Allowed NSSAI) instead configuring for the whole PLMN.

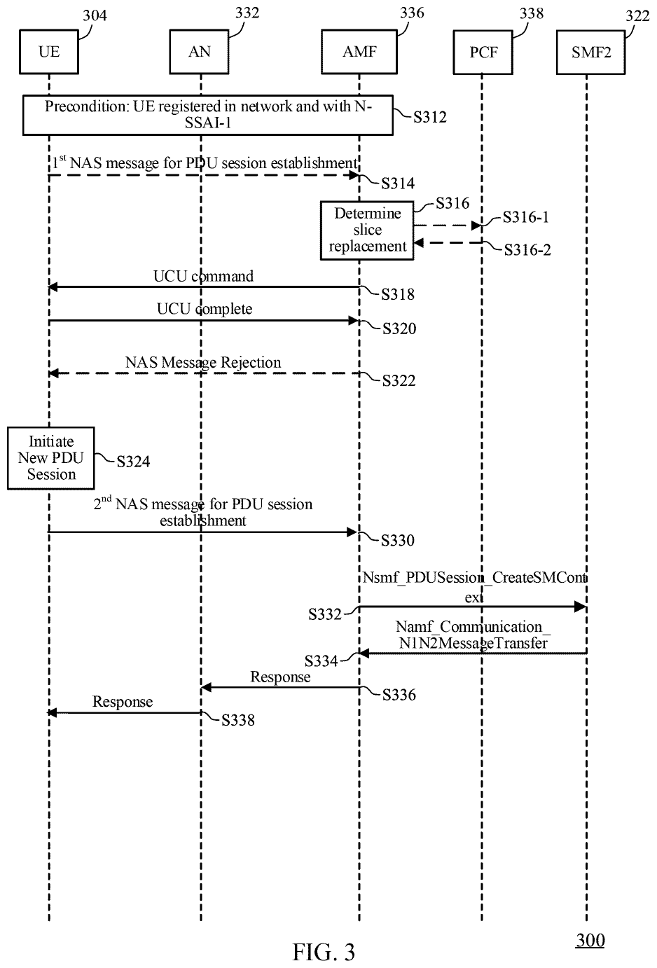

FIG. 3 illustrates a method 300 of reconfiguring a UE 302 in a communication network with an alternative second S-NSSAI (e.g. S-NSSAI-2) by using network slice mapping information. The UE 304 may be the UE 204 of FIG. 2, and the communication network may be the communication system 200 of FIG. 2.

The communication network may include an Access Network (AN) 332 which may correspond to the (R)AN 232 of FIG. 2, and an Access and Mobility Function (AMF) 336 and a Policy Control Function (PCF) 338 that may correspond to components of the CCNFs 234 of FIG. 2. Further, the communication network may include a second SMF (SMF2) 322 corresponding to the second SMF 222 of the second network slice 220 of FIG. 2; a first SMF corresponding to a second network slice 220 may be present but is not shown in FIG. 2. The first network slice is identified by the S-NSSAI-1, and the second network slice is identified by the S-NSSAI-2.

The detailed description of the steps FIG. 3 is as follows:

In a precondition step S312 that occurs before but is assumed to have occurred by the method 300, the UE requests registration with the network, specifically to register with a first network slice (e.g. S-NSSAI-1). The UE successfully registers with the network and S-NSSAI-1.

In step S314, The UE 3094 initiates the establishment of a PDU Session on S-NSSAI-1. The UE 304 sends, over the AN 332, a first NAS message to the AMF 336. The first NAS messages includes S-NSSAI-1, a Data Network Name (DNN), a PDU Session ID, a Request Type, and an N1 SM Container (containing the PDU Session Establishment Request message). The meaning of the parameters DNN, PDU Session ID, Request Type and others is the same as described in the UE Requested PDU Session Establishment procedure in reference TS 23.502, clause 4.3.2.2.

In step S316, the AMF 336 determines that the S-NSSAI-1 is not able to be used and that the S-NSSAI-1 should be replaced by a second alternative S-NSSAI (e.g. S-NSSAI-2). The reason why S-NSSAI-1 becomes unavailable can be one of: non-mobility event (e.g. OAM or NSSF/NF reconfiguration, S-NSSAI-1 will be down due to network maintenance); or UE mobility event (e.g. the T-AMF does not support S-NSSAI-1 or the S-NSSAI-1 is overloaded in T-AMF).

The determined alternative S-NSSAI-2 should be available in the current TA and not rejected for the UE (e.g., due to a previously failed NSSAA procedure). The UE context in the AMF 336 may contain multiple lists of rejected NSSAIs, e.g. rejected NSSAI for the current PLMN or SNPN, rejected NSSAI for the current registration area, rejected NSSAI for the failed or revoked NSSAA, rejected NSSAI for the maximum number of UEs reached.

If an Network Slice Selection Function(NSSF) of the communication system is responsible to determine the S-NSSAI-2, or the configured NSSAI, allowed NSSAI, and/or rejected NSSAI, the AMF 336 sends a request message to the NSSF wherein the request includes an indication that an alternative S-NSSAI to S-NSSAI-1 is required.

The AMF 336 determining to reject the UE's NAS message may include sending an appropriate reject cause value indicating that the PDU Session should be re-established by using the updated network slice configuration (i.e. indicating that S-NSSAI-2 replaces S-NSSAI-1). The updated network slice configuration can be sent to the UE either in the reject message (as shown in the step S322) or as part of the UCU procedure (as shown in the steps S318 and S320).

As described in the features above, the AMF may determine an S-NSSAI-2, which is part or not a part of the UE's subscribed and/or configured S-NSSAIs as corresponding to the replacement network slice. For example, in non-roaming case, the AMF may determine that the S-NSSAI-2 can be included in the Allowed NSSAI without mapping information if the S-NSSAI-2 is part of the UE's subscribed S-NSSAIs.

The AMF 336 should attempt to determine the S-NSSAI-2 to be a network slice associated with the same Network Slice Simultaneous Registration Group (NSSRG) information value and possibly the same Network Slice AS Group (NSAG) value as the S-NSSAI-1 in order to reduce the impact of the network slice change associated with interaction with other S-NSSAIs configured in the UE.

In some embodiments, step S316 may include a step S316-1 wherein the AMF 336 sends a check request for S-NSSAI-2 to the PCF 338 for the UE 304. The PCF 338 is responsible for creation and management of the URSP rules for the UE 304. In response to the check request, the PCF 338 determines whether S-NSSAI-2 is part of the URSP rule(s) in which the S-NSSAI-1 is also included. In other words, the AMF 336 requests a check of whether the URSP rule(s) using S-NSSAI-1 also contain additional RSD including S-NSSAI-2. If the AMF 336 knows that such additional RSDs including S-NSSAI-2 are available, the AMF 336 may determine that the UE 304 can rely on the URSP to trigger a new PDU Session establishment using the alternative RSD, when the RSD including the S-NSSAI-1 is not any longer valid (e.g. due to S-NSSAI-1 having restricted usage, or the S-NSSAI-1 being subject to replacements).

For example, at steps S316-1, the AMF 336 may send the PCF 338 the service operation Npcf_AMPolicyControl_Update request including a request “are there additional RSD with S-NSSAI-2 in the URSP rule(s) containing S-NSSAI-1”. In response, the PCF 338 inspects the URSP rules of the UE 304 and determines if the URSP rule(s) containing S-NSSAI-1 also contain additional RSDs with S-NSSAI-2. Then at step S316-2, the PCF 338 may respond to the AMF 336 with a service operation Npcf_AMPolicyControl_Update response containing the result, e.g. “S-NSSAI-2 is in alternative RSD for S-NSSAI-1” or “none” (meaning that the S-NSSAI-2 is not an alternative RSD for the S-NSSAI-1).

When the AMF 336 determines that the S-NSSAI-2 is not yet in the UE's Allowed NSSAI, not in the UE's Configured NSSAI and/or the S-NSSAI-2 should be configured to replace S-NSSAI-1, then at step S318 the AMF 336 initiates the UE Configuration Update (UCU) procedure in order to update the UE 304 network slice configuration to enable the use of S-NSSAI-2 and to configure the UE 304 so that the S-NSSAI-2 replaces the S-NSSAI-1. The AMF 336 may include in the UCU command message at least one of:
a configured NSSAI containing S-NSSAI-2 and in addition mapping of configured NSSAI information (S-NSSAI-2 maps to S-NSSAI-1, e.g. in case that the S-NSSAI-2 is not part of the UE's subscribed S-NSSAIs or currently Configured NSSAI);
an allowed NSSAI with corresponding mapping of allowed NSSAI information (containing the mapping of S-NSSAI-2 to S-NSSAI-1) wherein the allowed NSSAI includes the S-NSSAI-2 and excludes the S-NSSAI-1;
an Information Element “Replaced NSSAI” including the information that S-NSSAI-2 replaces S-NSSAI-1, or
a combination thereof.

The Information Element (IE) “Replaced NSSAI” may contain one or more parameters indicating that S-NSSAI-1 is allowed with restriction (or to be replaced), that S-NSSAI-2 replaces S-NSSAI-1, or both. The AMF 336 may provide the S-NSSAI-2 in the Allowed NSSAI and additionally the S-NSSAI-2 can be associated with a corresponding “Mapping Of Allowed NSSAI To Replaced NSSA” or “Replaced NSSAI” information. The “Replaced NSSAI” information indicates the S-NSSAI-2 is mapped to S-NSSAI-1 which is to be replaced. These new parameter(s) can be included in at least one of: as part of the Allowed NSSAI or associated with the Allowed NSSAI, as part of the Configured NSSAI or associated with the Configured NSSAI, as independent IEs, or combinations thereof.

As described in step S316, the S-NSSAI-1 is indicated to be (a) allowed and (b) to be replaced by another S-NSSAI. It is advantageous that the S-NSSAI-1 is marked/indicated as allowed so that the UE during the evaluation of the URSP rules for establishing of new PDU Session(s) will determine that the matching URSP rule containing an RSD with the S-NSSAI-1 as valid.

The Information Element “Replaced NSSAI” containing the parameters “S-NSSAI-1 is allowed with restriction”, and/or “S-NSSAI-2 replaces S-NSSAI-1” can be separate parameters or a single parameter having 2 meanings to the UE. The parameter “S-NSSAI-2 replaces S-NSSAI-1” is different from the parameter “S-NSSAI-2 maps to S-NSSAI-1” (which known as “Mapping Of Allowed NSSAI” information from [2]). In case of “S-NSSAI-2 replaces S-NSSAI-1”, the S-NSSAI-2 can be present in the Allowed NSSAI as individual (e.g. stand-alone) parameter without mapping information (e.g. in case that the S-NSSAI-2 is part of the UE's Subscribed S-NSSAIs) and PDU Sessions to S-NSSAI-2 can be established without associated “S-NSSAI-2 replaces S-NSSAI-1” information; whereas the parameter “S-NSSAI-2 maps to S-NSSAI-1” is always associated with the S-NSSAI-2 which is not part of the UE's subscribed S-NSSAIs. The parameter “S-NSSAI-1 is allowed with restriction” means that the S-NSSAI-1 can be evaluated as valid during the URSP evaluation, but when requesting a PDU Session towards the S-NSSAI-1, the UE (e.g. NAS MM sublayer) uses the S-NSSAI-2 to establish the PDU Session.

By excluding the S-NSSAI-1 from the Allowed NSSAI, but including the S-NSSAI-2 in the Allowed NSSAI which is also associated with the “Replaced NSSAI” information (containing the indication that S-NSSAI-2 replaces S-NSSAI-1), the UE is still able to use the URSP rule(s) having RSD including S-NSSAI-1. The reason is that the S-NSSAI-1 is included in the “Replaced NSSAI” information and the during the evaluation of the URSP rules the UE would consider the S-NSSAI-1 as valid but replaced by S-NSSAI-2.

In a first example of an Information Element “Replaced NSSAI” indicating Allowed NSSAI and the information that S NSSAI 1 is to be replaced by S NSSAI 2, wherein additional network slices can be allowed, the Information Element “Replaced NSSAI” may indicate:
S-NSSAI-2, S-NSSAI-2 to replace S-NSSAI-1;
S-NSSAI-3.

In a second example of an of an Information Element “Replaced NSSAI” indicating Allowed NSSAI and the information that S-NSSAI-1 is to be replaced by S-NSSAI-2, wherein additional network slices can be allowed, the Information Element “Replaced NSSAI” may indicate:
S-NSSAI-1 allowed with restriction, S-NSSAI-1 is to be replaced by S-NSSAI-2.
[Optionally S-NSSAI-2];
S-NSSAI-3.

In step S320, the UE 304 sends a UE configuration update (UCU) Complete message to the AMF 336 in order to confirm the successful processing of the UCU Command message received by the UE 304 in step S318. The UE 304 stores the network slicing configuration information that S-NSSAI-2 replaces S-NSSAI-1 and applies it for PDU Session(s) establishment for PDU Sessions which are triggered based on URSP rules including the S-NSSAI-1. The “Mapping Of Allowed NSSAI To NSSAI To Be Replaced” may be stored in the UE separately from the Mapping Of Allowed NSSAI information.

For example, in a roaming case to a VPLMN, the UE 304 may be provided with Configured NSSAI and associated mapping information that S-NSSAI-V (an S-NSSAI value used in the VPLMN) maps to the S-NSSAI-H (an S-NSSAI value used in the HPLMN to which the UE is subscribed and configured in the URSP rules). If the VPLMN decides to temporarily replace the S-NSSAI-V with S-NSSAI-2, then the AMF in the VPLMN may provide to the UE 304 the S-NSSAI-2 in the Allowed NSSAI and in addition the “Replaced NSSAI” information containing the S-NSSAI-2 replacing the S-NSSAI-V. In such case, the UE stores the “Replaced NSSAI” information that S-NSSAI-2 replaces S-NSSAI-V in addition to the mapping information that S-NSSAI-V maps to the S-NSSAI-H.

Note that steps S318 and S320 may be omitted in response to the AMF 336 determining in step 316 that S-NSSAI-2 is already part of the Allowed NSSAI of the UE 304. When steps S318 and S320 are omitted, the UE network slice re-configuration is performed in step S322 as described below.

In step S322, the AMF 336 sends to the UE 304 a rejection message to responsive to the first NAS message received by the AMF 336 in step S314. The rejection message may include at least one of: PDU Session ID, S-NSSAI-1, N1-SM Container, reject cause indicating that PDU Session re-establishment on replaced S-NSSAI is required, Informational Element “Replaced NSSAI”, or combinations thereof.

The reject cause indicating that PDU Session re-establishment on a replacement S-NSSAI is required is configured to indicate to the UE 304 that the UE 304 can initiate a new PDU Session establishment by using an S-NSSAI different from the S-NSSAI-1 used in the first NAS message. How the Informational Element “Replaced NSSAI” indicates that S-NSSAI-2 replaces S-NSSAI-1 may be the same or similar to the new Information Element “Replaced NSSAI” described in the description of step S318 above.

In one example, the Information Element “Replaced NSSAI” is sent in step S322 in response to the AMF 336 determining that there is no need to perform an UCU procedure as per steps S318 and S320. The UCU procedure may be omitted when the AMF 336 determines that the S-NSSAI-2 is already part of the Allowed NSSAI of the UE 304, i.e. the UE 304 can use the S-NSSAI-2 for PDU Session establishment without further configuration.

An example of the new Information Element sent to the UE 304 in step S322 contains at least one of indications that:
S-NSSAI-1 is allowed with restriction (e.g., used for URSP evaluation);
[S-NSSAI-1 is to be replaced by S-NSSAI-2] or [S-NSSAI-2 replaces S-NSSAI-1]; or combinations thereof

After receiving the information in step S322, the UE 304 may optionally wait for some time (e.g., pre-defined timer value may be started in the UE) or until a new UCU procedure is completed before performing step S324. The reason for the delay in the UE 304 is that it allows the network (e.g., the AMF 336) to reconfigured the UE, such as if steps S318 and S320 are performed after step S322. Such delay may be implicitly indicated by the reason for rejection from the AMF 336 to the UE 304, where the reject cause indicates that the UE 304 should use an alternative network slice (e.g., S-NSSAI-2) to establish a PDU Session which according to the URSP rules or local configuration should otherwise be established on S-NSSAI-1. This means that the UE 304 needs to have the corresponding configuration to be allowed to use the alternative S-NSSAI-2, i.e., the S-NSSAI-2 should be part of the Allowed NSSAI.

Steps S318 and S320 and step S322 may happen in any order, i.e., the steps S318 and S320 may be performed first before step S320, or step S320 may be performed first before steps S318 and S320, or only steps S318 and S320 may be performed, or only step S322 may be performed. In one example, the AMF 336 may decide to perform step S322 (and step S322 only) when the S-NSSAI-2 is already part of the Allowed NSSAI. In another example, the AMF may decide to first perform steps S318 and S320 and then perform step S322, in which case the message sent in step S322 may not include the new parameters, but may include the new reject cause, when the S-NSSAI-2 needs to be included in the Allowed NSSAI or configured NSSAI.

Also, steps S314 and S322 are shown as interrupted line to indicate that they may not happen and that the AMF 336 may perform step S316 without receiving a message for new PDU Session establishment from the UE 304 as described in step S314. In such case, the AMF 336 itself determines independent of the UE 304 that the S-NSSAI-1 should be replaced by S-NSSAI-2, and in response triggers steps S318 and S320 to reconfigure the UE 304 accordingly. In such a case, the steps S314 and S322 may not be performed.

At step S324, after receiving the new allowed NSSAI including S-NSSAI-2 and the replacing information of S-NSSAI-2 replaces S-NSSAI-1 (e.g., in steps S318 and S320), receiving the PDU Session reject indication from step S322, or both, the UE 304 initiates the establishment of a new PDU Session(s) for the user traffic to be routed to the S-NSSAI-1 according to the matching URSP rule or local configuration having the RSD including S-NSSAI-1. The UE 304 uses the S-NSSAI-2 from the allowed NSSAI, wherein S-NSSAI-2 is configured to replace S-NSSAI-1. In other words, the stored URSP rule(s) or local configuration which include RSD containing S-NSSAI-1 are used to establish the new PDU Session(s) but on S-NSSAI-2, as indicated according to the S-NSSAI replacing information, i.e. replacing/mapping of S-NSSAI-2 to S-NSSAI-1.

If there is an existing PDU Session established on S-NSSAI-1, when receiving the updated configuration in steps S318 and S320 where the S-NSSAI-1 is excluded from the Allowed NSSAI (and when the S-NSSAI-1 is included in the “Replaced NSSAI” IE) the UE 304 may not immediately trigger the release of the existing PDU Session, but may wait until the new PDU Session is established in the S-NSSAI-2. In other words, the UE 304 may keep the existing PDU Session established until a new PDU Session is established on the new S-NSSAI-2, and afterwards either the UE 304 initiates the existing PDU Session release, or the SMF of the existing PDU Session initiates the existing PDU Session release.

Note that there is a different UE behaviour and different NAS message content in the 2 cases described below:

In a first case, when the S-NSSAI-2 is part of the UE's Subscribed S-NSSAIs, i.e. the S-NSSAI-2 would be also included in one or more RSDs of one or more URSP rules, when there is application/user traffic matching to such URSP rules, the UE 304 initiates the PDU Session establishment procedure to S-NSSAI-2 wherein the second NAS message to the AMF 336 (i.e. the message carrying the N1 SM container with PDU Session establishment request) includes the S-NSSAI-2, but does not include the “replacement of S-NSSAI-1” (or “Replaced NSSAI”) information.

In a second case, when the application/user traffic matches to URSP rule which contains RSD with S-NSSAI-1, the UE 304 initiates the PDU Session establishment procedure to S-NSSAI-2 wherein the second NAS message to the AMF 336 (i.e. the message carrying the N1 SM container with PDU Session establishment request) includes the S-NSSAI-2 and the “replacement of S-NSSAI-1” (or “Replaced NSSAI”) information.

When the AMF 336 receives and processes the second NAS message (as is further described in relation to step S332), the AMF 336 is able to differentiate the two cases above depending whether the “replacement of S-NSSAI-1” (or “Replaced NSSAI”) information is present or not in the second NAS message.

At step S330, the UE applies the configuration received in steps S318 and S320 or in step S322 that S-NSSAI-2 replaces S-NSSAI-1 and the UE 304 triggers new PDU Session establishment to S-NSSAI-2 where the UE 304 includes in the second NAS message to the AMF 336 at least one of the following parameters: the S-NSSAI-2, replacement of S-NSSAI-1, DNN1, [if SSC3: old PDU Session ID], N1 SM container (PDU Session Establishment Request), etc.

The “replacement of S-NSSAI-1” information is a new parameter that is used by the UE 304 to indicate to the AMF 336 that the S-NSSAI-2 is used to replace S-NSSAI-1. This parameter is used to differentiate from the case when the UE 304 natively establishes a PDU Session to the S-NSSAI-2 based on the URSP rules, where the S-NSSAI-2 is part of the UE's Subscribed S-NSSAIs and the S-NSSAI-2 is included in a RSD of a URSP rule.

The second NAS SM message PDU Session Establishment Request encapsulated in the N1 SM container is sent transparently from the UE 304 via the AMF 336 to the SMF2 322. This message does not necessarily need to include the information about the “replacement of S-NSSAI-1”, as the SMF2 322 obtains the “replacement of S-NSSAI-1” information from the AMF 336 as shown in step S332.

Note that this solution may apply in non-roaming or roaming scenarios for home-routed traffic, where both the S-NSSAI-1 and S-NSSAI-2 are determined by the home network (e.g. HPLMN). In roaming scenarios, if the S-NSSAI-2 is determined to replace a network slice used in the visited network (e.g. VPLMN), then the 2^{nd} NAS message including the PDU Session establishment request contains the mapping of allowed NSSAI information can be used, and optionally or in addition, the replacing information of S-NSSAI-2 replaces S-NSSAI-1.

As the PDU Session is established on a new S-NSSAI (S-NSSAI-2), for PDU Session of SSC mode 1 and 2, the UE may either use a Request Type “initial request”, or use a Request Type “existing”. If the UE uses Request Type “existing”, the UE may include the old PDU Session ID. If the UE does not provide the old PDU Session ID and the Request Type “existing” is used, the AMF may internally determine that the new PDU Session on S-NSSAI-2 is associated with PDU Session on the S-NSSAI-1. For a PDU Session of SSC mode 3, the UE may use either Request Type “initial request” or “existing”, which should not have influence on the AMF operation, as the AMF is supposed to select an SMF using the S-NSSAI-2.

In step S322, the AMF 336 selects a serving SMF for the new PDU Session by using the S-NSSAI-2. Accordingly, the AMF 336 selects SMF2 322 and forwards the UE request of the 2^{nd} NAS message to the SMF2 322 using the Nsmf_PDUSession_CreateSMContext request service operation. The following may apply for the info sent from the AMF 336 to the SMF2 322:
If the S-NSSAI-2 is part of the UE's Subscribed S-NSSAIs, AMF 336 may only send to the SMF2 322 the S-NSSAI-2. The S-NSSAI-1 may not be required in the SMF2 322, as the SMF2 322 can retrieve from the UDM the relevant UE session management subscription data associated with S-NSSAI-2 by using the UE identity and the S-NSSAI-2 as key in the signalling request to the UDM. Alternatively, the AMF may also provide the replaced S-NSSAI-1 value to the SMF2 322. The SMF2 322 may also retrieve the relevant UE session management subscription data associated with S-NSSAI-1 by using the UE identity and the S-NSSAI-1 as key in the signalling request to the UDM. In the latter case, the SMF2 322 would have the UE session management subscription data associated with S-NSSAI-2 and the relevant UE session management subscription data associated with S-NSSAI-1. The SMF2 322 may merge both session management subscription data.
If the S-NSSAI-2 is not part of the UE's Subscribed S-NSSAIs, the AMF 336 should provide to the SMF2 322 both the S-NSSAI-2 and the replaced S-NSSAI-1. The SMF2 322 uses the S-NSSAI-1 to retrieve from the UDM the relevant UE session management subscription data associated with S-NSSAI-1. When later (not shown in the FIG. 3) the SMF2 322 registers with the UDM as serving SMF by using the service operation Nudm_UECM_Registration including UE SUPI, DNN, S-NSSAI-2, optionally the replaced S-NSSAI-1, PDU Session ID, SMF Identity, Serving PLMN ID, where all parameters are associated with the given PDU Session. As a result, the UDM may identify that the registration from SMF2 is associated with an existing registration for an old PDU Session, e.g. identified by S-NSSAI-1 and the DNN. The UDM may determine to replace the old association. The UDM may also store both the S-NSSAI-2 (as serving S-NSSAI) and the replaced S-NSSAI-1 in the UE's context.

The SMF2 322 proceeds with the establishment of PDU Session by using the S-NSSAI-2 as follows:
i. if the SMF2 322 is in the UE's HPLMN (i.e. non-roaming case or in roaming case with home-route traffic), the SMF2 322 uses the replaced/mapped S-NSSAI-1 value in the service operation to the UDM to retrieve the SM subscription data of the UE 304. The SMF2 322 does not use the S-NSSAI-2 value as input to select another SMF in the S-NSSAI-1. The SMF2 322 acts an anchor SMF for the PDU Session.
ii. if the SMF2 322 is in a VPLMN (i.e. roaming case and local breakout traffic), the SMF2 322 may determine to use the replaced/mapped S-NSSAI value (i.e. S-NSSAI-1) to select and contact an SMF in the HPLMN to establish a home-routed PDU Session. In such case the PDU Session establishment procedure for roaming scenario would apply where the SMF2 322 would control the intermediate UPF and the SMF in the HPLMN would serve the anchor UPF, i.e. an N9 tunnel is established between the intermediate UPF and the anchor UPF. If the PDU Session is to be for local break-out (LBO), the SMF2 322 uses the mapped S-NSSAI-1 value in the service operation to the UDM to retrieve the UE's SM subscription data and the SMF2 322 does not use the mapped S-NSSAI-1 value as input to select another SMF in the S-NSSAI-1 in the HPLMN.

The SMF2 322 retrieves the UE Session Management subscription data from the UDM by invoking the service operation Nudm_SDM_Get request including the parameters SUPI, Session Management Subscription data, selected DNN, S-NSSAI of the replaced S-NSSAI value (which is the S-NSSAI-1), etc. The S-NSSAI of the replaced S-NSSAI value is used also in non-roaming scenario.

In step S334, the SMF2 322 invokes the Namf Communication N1N2MessageTransfer service operation to the AMF 336, including the PDU Session ID, the N1 SM container (containing the PDU Session establishment accept/reject message), the N2 SM information/container (containing the information for the access network). The SMF2 322 acknowledges the establishment of the PDU Session to the UE 304 by sending PDU Session establishment accept message including the user plane configuration for PDU Session configuration.
The N2 SM information, which is destined to the access network (AN), includes the S-NSSAI-2 as network slice to be used in the access stratum, i.e. the replacing information that S-NSSAI-2 replaces S-NSSAI-1 is not provided to the RAN.
It is optionally possible that the SMF2 322 provides to the UE the “replacement of S-NSSAI-1” in the PDU Session establishment accept message, but it is not necessarily needed, as the UE 304 is aware that the S-NSSAI-2 is a replacement of the S-NSSAI-1 according to the request in step S330.

In step S336, the AMF 336 transmits a response corresponding to the communication received by the AMF 336 to the AN 332.

In step S338, the AN 332 forwards the response sent by the AMF 336 in step S336 to the UE 304.

The benefit of the solution in the FIG. 3 is that the AMF 336 rejects the UE 304 request for PDU Session establishment when the AMF 336 determines that the PDU Session should be established on alternative S-NSSAI-2 (in step S318). The AMF 336 includes in the NAS message rejection an appropriate reject cause that the PDU Session should be re-established by using an alternative network slice (e.g. the S-NSSAI-2) which replaces the current S-NSSAI-1.

It is advantageous that the UE 304 is configured in the MM sub-layer appropriately that the S-NSSAI-2 is allowed and that S-NSSAI-2 replaces S-NSSAI-1, as the UE 304 can appropriately apply other network slice features like Network Slice AS Groups (e.g. as described in clause 5.15.14 in TS 23.501), or the UE 304 would provide the correct S-NSSAI-2 to the access stratum (AS), so that the NG-RAN can apply the appropriate access control or AMF selection.

Accordingly, embodiments include a network function, such as an AMF, configured to perform one or more of:
Determining to configure the UE with network slice information that a second network slice corresponding to a second S-NSSAI (S-NSSAI-2) replaces a first network slice corresponding to a first S-NSSAI (S-NSSAI-1) and the first network slice is allowed with restriction (wherein “allowed with restriction” may mean that the S-NSSAI-1 is not included in the allowed NSSA, but included in the information which indicates that S-NSSAI-2 replaces S-NSSAI-1, e.g. Replaced NSSAI).
Upon reception of a PDU Session establishment request message including S-NSSAI-1, sending a reject message with a cause indicating that PDU Session should be re-established by using an alternative network slice (e.g. corresponding S-NSSAI-2) which replaces the network slice corresponding to S-NSSAI-1.
Transmitting a request to the SMF including both the S-NSSAI-2 and the replaced S-NSSAI-1, so that the S-NSSAI-1 may be used to retrieve the Session Management Subscription data from the UDM.

Also accordingly, embodiments include a User Equipment (UE) configured to perform one or more of:
Receiving a new PDU Session establishment reject cause from the AMF indicating that a PDU Session is to be re-established on an alternative network slice (e.g., S-NSSAI-2).
Receiving one or more new parameters (e.g. one or more Information Elements, IE) indicating that S-NSSAI-1 is allowed with restriction, that S-NSSAI-2 replaces S-NSSAI-1, or both.
Sending a PDU Session establishment request to the AMF, where the PDU Session is to S-NSSAI-2, and additionally including a new parameter indicating that the S-NSSAI-2 is to replace S-NSSAI-1.

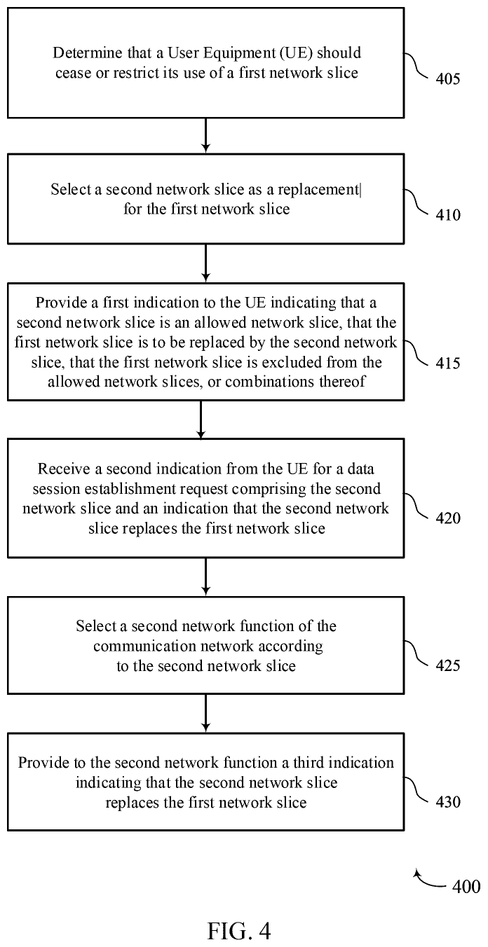

FIG. 4 illustrates a flowchart of a method 400 that supports data session establishment on a different network slice in accordance with aspects of the present disclosure. The operations of the method 400 may be implemented by a device or its components as described herein. For example, the operations of the method 400 may be performed by a network function of a wireless communication system 100 or communication system 200 as described with reference to FIGS. 1 through 2. In some implementations, the device may execute a set of instructions to control the function elements of the device to perform the described functions. Additionally, or alternatively, the device may perform aspects of the described functions using special-purpose hardware.

At 405, the method 400 may include determining that a UE should cease or restrict its use of a first network slice indicated as an allowed network slice of the UE. The operations of 405 may be performed in accordance with examples as described herein. In some implementations, aspects of the operations of 405 may be performed by a device as described with reference to FIG. 1.

At 410, the method 400 may include selecting a second network slice as a replacement for the first network slice. The operations of 410 may be performed in accordance with examples as described herein. In some implementations, aspects of the operations of 410 may be performed by a device as described with reference to FIG. 1.

At 415, the method 400 may include providing a first indication to the UE, the first indication indicating that a second network slice is an allowed network slice, that the first network slice is to be replaced by the second network slice, that the first network slice is excluded from the allowed network slices, or combinations thereof. The operations of 415 may be performed in accordance with examples as described herein. In some implementations, aspects of the operations of 415 may be performed by a device as described with reference to FIG. 1.

At 420, the method 400 may include receiving a second indication from the UE for a data session establishment request comprising the second network slice and an indication that the second network slice replaces the first network slice. The operations of 420 may be performed in accordance with examples as described herein. In some implementations, aspects of the operations of 420 may be performed by a device as described with reference to FIG. 1.

At 425, the method 400 may include selecting a second network function of the communication network according to the second network slice. The operations of 425 may be performed in accordance with examples as described herein. In some implementations, aspects of the operations of 425 may be performed by a device as described with reference to FIG. 1.

At 430, the method 400 may include providing to the second network function a third indication indicating that the second network slice replaces the first network slice. The operations of 430 may be performed in accordance with examples as described herein. In some implementations, aspects of the operations of 430 may be performed by a device as described with reference to FIG. 1.

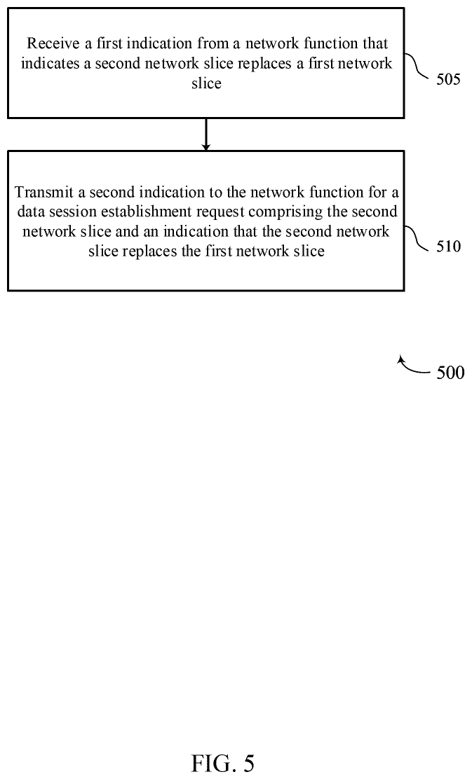

FIG. 5 illustrates a flowchart of a method 500 that supports data session establishment on a different network slice in accordance with aspects of the present disclosure. The operations of the method 500 may be implemented by a device or its components as described herein. For example, the operations of the method 500 may be performed by a User Equipment (UE) 104 or UE 204 as described with reference to FIGS. 1 through 2. In some implementations, the device may execute a set of instructions to control the function elements of the device to perform the described functions. Additionally, or alternatively, the device may perform aspects of the described functions using special-purpose hardware.

At 505, the method 500 may include receiving a first indication from a network function that indicates a second network slice replaces a first network slice. The operations of 505 may be performed in accordance with examples as described herein. In some implementations, aspects of the operations of 505 may be performed by a device as described with reference to FIG. 1.

At 510, the method 500 may include transmitting a second indication to the network function for a data session establishment request comprising the second network slice and an indication that the second network slice replaces the first network slice. The operations of 510 may be performed in accordance with examples as described herein. In some implementations, aspects of the operations of 510 may be performed by a device as described with reference to FIG. 1.

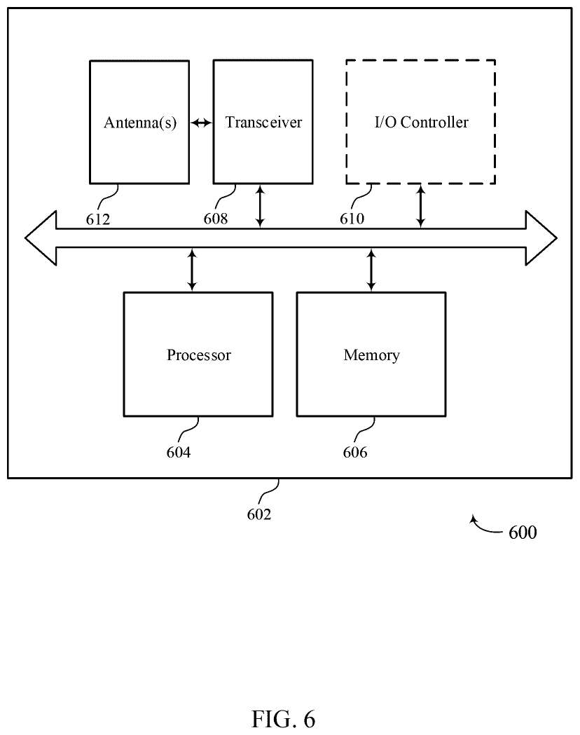

FIG. 6 illustrates an example of a block diagram 600 of a device 602 that supports data session establishment on a different network slice in accordance with aspects of the present disclosure. The device 602 may be an example of a UE 104 as described in herein, or of a component of the wireless communication system 100 that supports one or more Control-plane Network Functions, such as an Access and Mobility Function (AMF). The device 602 may support wireless communication with one or more network entities 102, UEs 104, or any combination thereof. The device 602 may include components for bi-directional communications including components for transmitting and receiving communications, such as a processor 604, a memory 606, a transceiver 608, and an I/O controller 610. These components may be in electronic communication or otherwise coupled (e.g., operatively, communicatively, functionally, electronically, electrically) via one or more interfaces (e.g., buses).

The processor 604, the memory 606, the transceiver 608, or various combinations thereof or various components thereof may be examples of means for performing various aspects of the present disclosure as described herein. For example, the processor 604, the memory 606, the transceiver 608, or various combinations or components thereof may support a method for performing one or more of the operations described herein.

In some implementations, the processor 604, the memory 606, the transceiver 608, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 604 and the memory 606 coupled with the processor 604 may be configured to perform one or more of the functions described herein (e.g., executing, by the processor 604, instructions stored in the memory 606).

For example, the processor 604 may support wireless communication at the device 602 in accordance with examples as disclosed herein.

Processor 604 may be configured as or otherwise support a means for determining that a UE should cease or restrict its use of a first network slice; selecting a second network slice as a replacement for the first network slice; providing to the UE a first indication indicating that a second network slice is an allowed network slice, that the first network slice is to be replaced by the second network slice, or combinations thereof; receiving a second indication from the UE for a data session establishment request comprising the second network slice and an indication that the second network slice replaces the first network slice; selecting a second network function of the communication network according to the second network slice; providing to the second network function a third indication indicating that the second network slice replaces the first network slice, or combinations thereof.

Processor 604 may further or in the alternative be configured as or otherwise support a means for providing, to a network function of the communication network, a first data session establishment request for a first network slice; receiving, from the network function, a rejection of the first data session establishment request, the rejection indicating that the data session may be reestablished on a different network slice, that the first network slice is to be replaced or restricted, or combinations thereof; in response to receiving the rejection of the first data session establishment request, providing, to the network function, a second data session establishment request for a second network slice; or combinations thereof.

Processor 604 may further or in the alternative be configured as or otherwise support a means for receiving a first indication from a network function that indicates a second network slice replaces a first network slice, and transmitting a second indication to the network function for a data session establishment request comprising the second network slice and an indication that the second network slice replaces the first network slice.

The processor 604 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 604 may be configured to operate a memory array using a memory controller. In some other implementations, a memory controller may be integrated into the processor 604. The processor 604 may be configured to execute computer-readable instructions stored in a memory (e.g., the memory 606) to cause the device 602 to perform various functions of the present disclosure.

The memory 606 may include random access memory (RAM) and read-only memory (ROM). The memory 606 may store computer-readable, computer-executable code including instructions that, when executed by the processor 604 cause the device 602 to perform various functions described herein. The code may be stored in a non-transitory computer-readable medium such as system memory or another type of memory. In some implementations, the code may not be directly executable by the processor 604 but may cause a computer (e.g., when compiled and executed) to perform functions described herein. In some implementations, the memory 606 may include, among other things, a basic I/O system (BIOS) which may control basic hardware or software operation such as the interaction with peripheral components or devices.

The I/O controller 610 may manage input and output signals for the device 602. The I/O controller 610 may also manage peripherals not integrated into the device 602. In some implementations, the I/O controller 610 may represent a physical connection or port to an external peripheral. In some implementations, the I/O controller 610 may utilize an operating system such as iOS®, ANDROID®, MS-DOS®, MS-WINDOWS®, OS/2®, UNIX®, LINUX®, or another known operating system. In some implementations, the I/O controller 610 may be implemented as part of a processor, such as the processor 604. In some implementations, a user may interact with the device 602 via the I/O controller 610 or via hardware components controlled by the I/O controller 610.

In some implementations, the device 602 may include a single antenna 612. However, in some other implementations, the device 602 may have more than one antenna 612 (i.e., multiple antennas), including multiple antenna panels or antenna arrays, which may be capable of concurrently transmitting or receiving multiple wireless transmissions. The transceiver 608 may communicate bi-directionally, via the one or more antennas 612, wired, or wireless links as described herein. For example, the transceiver 608 may represent a wireless transceiver and may communicate bi-directionally with another wireless transceiver. The transceiver 608 may also include a modem to modulate the packets, to provide the modulated packets to one or more antennas 612 for transmission, and to demodulate packets received from the one or more antennas 612.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A first network function of a communication network, the first network function comprising:
at least one memory; and
at least one processor coupled with the at least one memory and configured to cause the first network function to:
determine that a user equipment (UE) is to cease or restrict its use of a first network slice indicated as an allowed network slice of the UE;
select a second network slice as a replacement for the first network slice;
provide a first indication to the UE,
wherein the first indication:
indicates that the second network slice is the allowed network slice,
includes mapping information indicating that the first network slice is to be replaced by the second network slice,
or combinations thereof;
receive a second indication from the UE for a data session establishment request comprising the second network slice and the first network slice;
select a second network function of the communication network according to the second network slice; and
provide to the second network function a third indication indicating the second network slice and the first network slice.

2. The first network function of claim 1, wherein providing the first indication to the UE comprises:
providing a UE Configuration Update (UCU) command message to the UE, the UCU command message including an indication that the second network slice is the allowed slice, an indication that the first network slice is to be replaced by the second network slice, or both; and
receiving from the UE a UCU complete message responsive to the UCU command message.

3. The first network function of claim 1, wherein the at least one processor is further configured to cause the first network function to:
receive, from the UE, a first data session establishment request for the first network slice; and
determining that the UE should cease or restrict its use of the first network slice in response to receiving the first data session establishment request.

4. The first network function of claim 3, wherein providing the first indication to the UE comprises:
providing to the UE a message indicating that the first data session establishment request has been rejected, wherein the message further indicates that the UE may reestablish the data session on a different network slice, that the first network slice is to be replaced, that the second network slice replaces the first network slice, or a combination thereof.

5. The first network function of claim 1, wherein providing to the second network function the third indication is performed in response to receiving the second indication.

6. The first network function of claim 5, wherein the second network function is provided the second indication using a request service operation, and
wherein the request service operation further includes information from the second indication and is configured to cause the second network function to create a data session on the second network slice.

7. The first network function of claim 1, wherein the first network slice being an allowed network slice of the UE is determined according to Network Slice Selection Assistance Information (NSSAI) of the UE.

8. The first network function of claim 1, wherein selecting the second network slice comprises determining that the second network slice is not an allowed network slice of the UE.

9. The first network function of claim 8, wherein determining that the second network slice is not an allowed network slice of the UE comprises:
determining that the second network slice is not an allowed network slice of the UE according to Network Slice Selection Assistance Information (NSSAI) of the UE, according to the UE subscription data, according to UE Route Selection Policy (URSP) rules for the UE and application traffic of the UE using the first network slice, or combinations thereof.

10. The first network function of claim 9, wherein determining the second network slice not being the allowed network slice according to the URSP rules for the UE and the application traffic of the UE using the first network slice includes:
providing to a third network function of the communication network a request to determine whether the second network slice qualifies as a network slice to be used alternatively to the first network slice according to the URSP rules; and
receiving from the third network function an indication of whether the second network slice qualifies as an allowed network slice according to the URSP rules.

11. A user equipment (UE) for wireless communication, comprising:
at least one memory; and
at least one processor coupled with the at least one memory and configured to cause the UE to:
receive a first indication from a network function that indicates a second network slice is an allowed network slice and that the second network slice replaces a first network slice;
transmit a second indication to the network function for a data session establishment request comprising the second network slice and the first network slice.

12. The UE of claim 11, wherein the at least one processor is further configured to cause the UE to:
receive, from the network function, a rejection of a previous data session establishment request before receiving the first indication from the network function.

13. The UE of claim 12, wherein the rejection of the first data session establishment request comprises a UE Configuration Update (UCU) command message, the UCU command message including an indication that the second network slice is an allowed slice, an indication that the first network slice is to be replaced by the second network slice, or both.

14. The UE of claim 12, wherein the rejection of the first data session establishment request comprises a message indicating that the first data session establishment request has been rejected, the message further indicating that the first network slice is to be replaced, that the second network slice replaces the first network slice, or both.

15. The UE of claim 11, wherein the at least one processor is further configured to cause the UE to:
receive, from the network function, information indicating that a second network slice is an allowed network slice, that the first network slice is to be replaced by the second network slice, or combinations thereof.

16. The UE of claim 13, wherein the information is included in a rejection of a previous data session establishment request.

17. A processor for wireless communication, comprising:
at least one controller coupled with at least one memory and configured to cause the processor to:
provide, to a network function of a communication network, a first data session establishment request for a first network slice;
receive, from the network function, a rejection of the first data session establishment request, the rejection indicating that the data session may be reestablished on a different network slice, that the first network slice is to be replaced or restricted, or combinations thereof; and
in response to receiving the rejection of the first data session establishment request, provide, to the network function, a second data session establishment request for a second network slice.

18. The processor of claim 17, wherein the second data session establishment request includes an indication of the second network slice, an indication that the second network slice is a replacement for the first network slice, or both.

19. A method performed by a user equipment (UE), the method comprising:
providing, to a network function of a communication network, a first data session establishment request for a first network slice;
receiving, from the network function, a rejection of the first data session establishment request, the rejection indicating that the data session may be reestablished on a different network slice, that the first network slice is to be replaced or restricted, or combinations thereof; and
in response to receiving the rejection of the first data session establishment request, providing, to the network function, a second data session establishment request for a second network slice.

20. The method of claim 10, wherein the second data session establishment request includes an indication of the second network slice, an indication that the second network slice is a replacement for the first network slice, or both.
